(19) United States
(12) Patent Application Publication
(10) Pub. No.: US 2018/0031527 A1
(43) Pub. Date: Feb. 1, 2018

(54) ON-LINE GAS CHROMATOGRAPHY SYSTEM AND THE USE THEREOF FOR ANALYZING CATALYTIC REACTIONS

(71) Applicant: SABIC Global Technologies B.V., Bergen op Zoom (NL)

(72) Inventors: YongMan Choi, Riyadh (SA); Abdullah N. Al-Nafisah, Riyadh (SA); Ramsey Bunama, Riyadh (SA); Khalid M. El-Yahyaoui, Riyadh (SA)

(21) Appl. No.: 15/548,835

(22) PCT Filed: Feb. 4, 2016
(86) PCT No.: PCT/IB2016/050581

§ 371 Date: Aug. 4, 2017

Related U.S. Application Data
(60) Provisional application No. 62/112,912, filed on Feb. 6, 2015.

(51) Int. Cl. G01N 30/32; B01J 19/24; B01J 8/00; G01N 30/68; B01J 8/02

(52) U.S. Cl. CPC G01N 30/32; G01N 30/68; B01J 8/0278; B01J 8/001; B01J 19/2455; G01N 2030/025

(57) ABSTRACT

An on-line gas chromatography system for a fixed-bed continuous flow reactor and a method for on-line gas analysis of a catalytic reaction using the gas chromatography system. A reactor flow loop, a gas chromatogram, and a hydrostatic regulator are present in the gas chromatography system, wherein the reactor flow loop contains a fixed-bed reactor, a purge gas source, a feed gas source, and a by-pass line for reaction calibration.

### TECHNICAL FIELD

The present disclosure relates to an on-line gas chromatography system for a fixed-bed continuous flow reactor and a method for on-line gas analysis of catalytic reactions using the gas chromatography system.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

In reactions that involve gaseous reactants or products, accurate on-line gas chromatography (GC) analyses for in situ catalytic experiments is an important method for obtaining reliable and reproducible reaction analysis. In particular, determination of conversion, selectivity and yield are essential reaction parameters for monitoring and optimizing catalytic reactions. To accurately measure the conversion, selectivity, and yield for catalytic reactions, a calibration is essential. In general, a calibration curve is obtained with or without passing through a catalytic reactor. Then based on the curve, an unknown concentration of chemical species may be calculated. Pre-mixed gases are generally used to obtain a response factor (RF) of each species in product gases. Then based on the RF, the concentration of chemical species can be calculated. For catalytic experiments involving hydrocarbon cracking or dehydrogenation reactions, a fixed-bed micro reactor is commonly used to perform the reaction, and GC is often used to analyze the reaction results.

In general, calibration processes are performed at ambient temperature, while catalytic experiments in heterogeneous catalysis are commonly carried out at high temperatures in order to activate catalysts. In such a scenario, experimental errors resulting from an inaccurate feed concentration, gas pressure drop, etc., are unavoidable during reaction analysis. Calibrations performed prior to a reaction may not account for all experimental errors. For example, reactions that require modification of gaseous reactants or gaseous reactant ratios, unexpected errors arising from a low-pressure reactant or inconsistent pre-mixing in the gas line may be introduced. This error is then propagated to the calculations of carbon and hydrogen balances even though an extensive pre-reaction calibration is performed. Even small errors, when present in reactions of industrial scale, such as chemical plants, can dramatically impact production rates and yields.

Due to the importance of accurate GC analysis in reaction monitoring, GC design improvements are evolving. For example, Echrom Technologies Shanghai Co. (Chinese Patent No. CN202494668U—incorporated herein by reference in its entirety) disclosed a high temperature and high pressure on-line GC analyzing system incorporating precision filters and multi-way valves for improving stability and parallelism of detection results for a multi gas system.

Kawana, S. (Japanese Patent Application No. JP 20140352406A1—incorporated herein by reference in its entirety) disclosed a GC apparatus that may be switched between an analysis mode and a standby mode for improving stability between analysis runs.

In view of the forgoing, one aspect of the present disclosure is to provide an on-line gas chromatography system for a fixed-bed continuous flow reactor and a method for on-line gas analysis of catalytic reactions using the gas chromatography system.

### BRIEF SUMMARY OF THE DISCLOSURE

An on-line gas chromatography system for a fixed-bed continuous flow reactor, comprises: a reactor flow loop, comprising: a fixed-bed continuous flow reactor having a reactor gas feed line and a reactor gas output line, a purge gas source, a feed gas source, and a by-pass line; wherein the by-pass line, the reactor gas feed line, the reactor gas output line, the purge gas source, and the feed gas source, are in fluid communication; a gas chromatogram having a gas chromatogram gas inlet line and a gas chromatogram gas outlet line; and a hydrostatic pressure regulator, comprising: a vessel, an exit end of the gas chromatogram gas outlet line, an exit end of the by-pass line, and a liquid; wherein the vessel contains the liquid and the vessel is in fluid communication with the exit end of the gas chromatogram gas outlet line and the exit end of the by-pass line; and wherein the exit end of the by-pass line is submerged in the liquid at a first depth and the exit end of the gas chromatogram gas outlet line is submerged in the liquid at a second depth that is less than the first depth, wherein the gas chromatogram gas outlet line has a first hydrostatic pressure and the by-pass line has a second hydrostatic pressure, and the first hydrostatic pressure is less than the second hydrostatic pressure; wherein the gas chromatogram is downstream of and in fluid communication with the reactor gas output line and the by-pass line through the gas chromatogram gas inlet line, and the gas chromatogram is upstream of and in fluid communication with the hydrostatic pressure regulator through the GC gas outlet line; and wherein the reactor gas output line is in fluid communication with the gas chromatogram without a pump.

A method for on-line gas analysis of a catalytic reaction in the on-line gas chromatography system of any of the preceding embodiments, comprises: flowing a calibration gas mixture through the by-pass line into the gas chromatogram through the gas chromatogram gas inlet line to record the composition of the calibration gas mixture; feeding a reactor gas mixture through the fixed-bed continuous flow reactor to yield a gaseous reaction product; and feeding only the gaseous reaction product exiting the fixed-bed continuous flow reactor to the GC gas inlet line to determine the composition of the gaseous reaction product.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration of the on-line gas chromatography system.

FIG. 2 is a general depiction of a PC control unit.

### DETAILED DESCRIPTION OF THE EMBODIMENTS

According to a first aspect, the present disclosure relates to an on-line gas chromatography system for a fixed-bed continuous flow reactor. The on-line gas chromatography system can contain a reactor flow loop, which can include a fixed-bed continuous flow reactor having a reactor gas feed line and a reactor gas output line, a purge gas source, a feed gas source, and a by-pass line. The by-pass line, the reactor gas feed line, the reactor gas output line, the purge gas source, and the feed gas source, can be in fluid communication with one another. The on-line gas chromatography system can include a gas chromatogram (GC) having a GC gas inlet line and a GC gas outlet line and a hydrostatic pressure regulator, which includes a vessel, an exit end of the GC gas outlet line, an exit end of the by-pass line, and a liquid.

In the on-line gas chromatography system, the vessel contains the liquid and the vessel is in fluid communication with the exit end of the GC gas outlet line and the exit end of the by-pass line, wherein the exit end of the by-pass line is submerged in the liquid at a first depth and the exit end of the GC gas outlet line is submerged in the liquid at a second depth that is less than the first depth. The GC gas outlet line has a first hydrostatic pressure and the by-pass line has a second hydrostatic pressure, and the first hydrostatic pressure is less than the second hydrostatic pressure. The gas chromatogram is downstream of and in fluid communication with the reactor gas output line and the by-pass line through the GC gas inlet line, and the gas chromatogram is upstream of and in fluid communication with the hydrostatic pressure regulator through the GC gas outlet line. The reactor gas output line is in fluid communication with the gas chromatogram without a pump.

In one embodiment, the on-line gas chromatography system also has a purge line in fluid communication with the reactor gas feed line upstream of the continuous flow reactor, the purge gas source, and separate from the feed gas source. In one embodiment, the on-line gas chromatography system also includes a first three-way valve downstream of the purge gas source, and the feed gas source, upstream of the by-pass line and the reactor gas feed line. In one embodiment, the on-line gas chromatography system also includes a second three-way valve downstream of the reactor gas output line and upstream of the by-pass line and the GC gas inlet line. In one embodiment, the on-line gas chromatography system further incorporates a PC controlling unit, wherein the PC controlling unit controls a mass flow of the feed gas and the purge gas in the on-line gas chromatography system. In one embodiment, the gas chromatogram comprises a flame ionization detector. In one embodiment, the fixed-bed continuous flow reactor comprises a catalyst. In one embodiment, the catalyst comprises chromium oxide. In one embodiment, the feed gas is a hydrocarbon gas. In one embodiment, the purge gas is argon, nitrogen, or a combination comprising at least one of the foregoing.

According to a second aspect, the present disclosure relates to a method for on-line gas analysis of a catalytic reaction in the on-line gas chromatography system. The method involves i) first flowing a calibration gas mixture through the by-pass line into the gas chromatogram through the GC gas inlet line to record the composition of the calibration gas mixture, then ii) feeding a reactor gas mixture through the fixed-bed continuous flow reactor to yield a gaseous reaction product iii) feeding only the gaseous reaction product exiting the fixed-bed continuous flow reactor to the GC gas inlet line to determine the composition of the gaseous reaction product.

In one embodiment, the calibration gas mixture and the reactor gas mixture can be the same, and the mixture can comprise a hydrocarbon gas, a purge gas, or a combination comprising at least one of the foregoing. In one embodiment, the calibration gas mixture and the reactor gas mixture can be the same, and the mixture can comprise 80-90% of a hydrocarbon gas and 10-20% of a purge gas. In one embodiment, the reactor gas mixture can comprise a hydrocarbon gas, the catalytic reaction can be a hydrocarbon dehydrogenation reaction, and the composition of gaseous reaction product can comprise a dehydrogenated reaction product. In one embodiment, the reactor gas mixture can comprise a hydrocarbon gas, the catalytic reaction can be a hydrocarbon cracking reaction, and the composition of gaseous reaction product can comprise a cracked hydrocarbon reaction product.

Referring now to the drawings, wherein like reference numerals designate identical or corresponding parts throughout the several views.

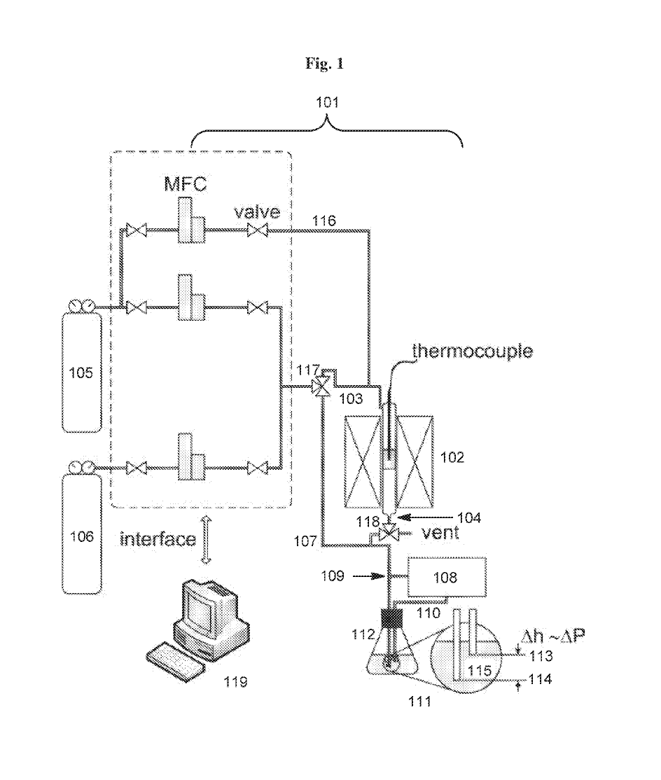

According to a first aspect, the present disclosure relates to an on-line gas chromatography system for a fixed-bed continuous flow reactor. As shown in FIG. 1, the on-line gas chromatography system contains a reactor flow loop 101, which includes a fixed-bed continuous flow reactor 102 having a reactor gas feed line 103 and a reactor gas output line 104, a purge gas source 105, a feed gas source 106, and a by-pass line 107. The by-pass line 107, the reactor gas feed line 103, the reactor gas output line 104, the purge gas source 105, and the feed gas source 106 are in fluid communication. The purge gas source 105 and the feed gas source 106 are located upstream of the by-pass line 107 and the reactor gas feed line 103. The by-pass line 107 and the reactor gas feed line 103 are connected upstream of the continuous flow reactor and in parallel to the purge gas source 105 and the feed gas source 106. The reactor gas output line 104 is located downstream of the reactor gas feed line 103, and is fluidly connected to the by-pass line 107 downstream of the continuous flow reactor.

In chemical processing, a fixed-bed reactor is a hollow tube, pipe, or other vessel that is filled with catalyst particles or adsorbents such as zeolite pellets, granular activated carbon, crushed metal oxide particles, etc. The purpose of a fixed-bed is typically to improve contact between two phases in a chemical or similar process. In a chemical reactor, a fixed-bed reactor is most often used to catalyze gas reactions and the reaction takes place on the surface of the catalyst. The advantage of using a fixed-bed reactor is the higher conversion per weight of catalyst than other catalytic reactors. The conversion is based on the amount of the solid catalyst rather than the volume of the reactor.

In one embodiment, the reactors of the present invention can include a silicon-oxygen framework (e.g. quartz) or a metal alloy (e.g. Inconel). In one embodiment, temperature of the continuous flow reactor can be controlled and maintained by a tube furnace.

In one embodiment, the fixed-bed continuous flow reactor can comprise a catalyst. For example, the catalyst can include, but is not limited to zeolites, acid treated metal oxides (e.g. acid treated alumina), acid treated clays or metal oxides. Zeolites are microporous, aluminosilicate minerals. Some of the more common mineral zeolites are analcime, chabazite, clinoptilolite, heulandite, natrolite, phillipsite, and stilbite. Synthetic catalysts can include composites of silica and alumina or other metal oxides, including silica-alumina, silica-magnesia, silica-zirconia, silica-thoria, silica-beryllia, silica-titania, silicavanadia, as well as ternary combinations such as silica-alumina-magnesia, silica-alumina-zirconia, and silica-magnesia-zirconia. Other bifunctional catalysts can include, platinum and/or rhodium doped zeolites, and platinum-alumina. Acid treated natural clays which may be suitable for use as the catalyst in the invention include can include kaolins, sub-bentonites, montmorillonite, fullers earth, and halloysite. In one embodiment, the catalyst can comprise chromium oxide.

In terms of the present disclosure, the catalyst can be supported on a catalyst support. For purposes of the present disclosure, the catalyst support can refer to a high surface area material to which a catalyst is affixed. The support can be inert or can participate in catalytic reactions. The reactivity of heterogeneous catalysts and nanomaterial-based catalysts occurs at the surface atoms. Consequently great effort is made to maximize the surface area of a catalyst by distributing it over the support. Typical supports include various kinds of carbon, alumina, and silica. In one embodiment, the catalyst support is aluminum oxide. The catalyst support may be comprised of a plurality of different crystallographic phases.

Therefore, in terms of alumina, the catalyst support can comprise α-Al₂O₃, γ Al₂O₃, η-Al₂O₃, θ-Al₂O₃, χ-Al₂O₃, κ-Al₂O₃, and δ-Al₂O₃, or a mixture thereof.

In one embodiment, the on-line gas chromatography system optionally comprises a first filter located in the reactor gas feed line, upstream of the continuous flow reactor. The first filter, if present, can remove solid or liquid particles from the gaseous mixture prior to entering the continuous flow reactor.

In one embodiment, the feed gas can be a hydrocarbon gas. Hydrocarbon gas can refer to any simple organic compound containing carbon and hydrogen, such as ethane, propane, butane, etc., or C₂, C₃, C₄, C₅, C₆, C₇, C₈, etc. containing compounds. Hydrocarbon gas may also refer to any higher molecular weight hydrocarbon feedstocks, e.g., aromatic hydrocarbons, cycloalkanes, naphtha, high boiling or heavy fractions of petroleum, petroleum residuum, shale oil, tar sand oil, coal and the like.

In the present disclosure, the purge gas can be any inert gas. An inert gas can be any gas that does not readily undergo chemical reactions. The inert gas can be, but is not limited to, atomic nitrogen, helium, neon, argon, krypton, xenon, radon, or mixtures thereof. In one embodiment, the purge gas is argon, nitrogen, or a combination comprising at least one of the foregoing.

The on-line gas chromatography system also includes a gas chromatogram 108 having a GC gas inlet line 109 and a GC gas outlet line 110.

A gas chromatogram (GC) is an apparatus which feeds a gas sample into a column via a carrier gas, separates the respective components in the gas sample over time inside the column, and detects the components with a detector provided at the column outlet. In a typical instrument, the carrier gas is continuously passed through the chamber or column which is packed with a granular material having particular adsorption characteristics or which is coated with a liquid having particular gas or vapor solubility characteristics. Since the rates at which the respective components move into the column differ depending on the strengths of the interactions between the respective components in the sample and a stationary phase inside the column, the respective components are separated over time. At this time, the flow rate of the carrier gas is set to a rate within an optimal flow rate range at which the components in the sample can be sufficiently separated and at which peaks with sharp shapes can be obtained. In the present disclosure, the flow rate of the carrier gas in the GC is 0.5-20, preferably 0.8-15, more preferably 1-10 milliliters per minute (ml/min). In one embodiment, the GC column is a capillary column or a packed column. Helium, hydrogen, or nitrogen gas can be used as a carrier gas depending on what gaseous components require detection. The rates at which the carrier gas or the respective components in the sample move into the column change due to the temperature or the like inside the column. Therefore, analysis cannot be performed accurately until these are stabilized. However, a long amount of time is required from when the power of the apparatus is turned on until the temperature or the like inside the column is stabilized at a prescribed value. Therefore, even if there is a certain amount of time after a given analysis is completed until the next analysis is performed, it is desirable to maintain a standby state in which the temperature or the like inside the column is stabilized at a prescribed value in the same manner as at the time of analysis while the power is kept on. The carrier gas is circulated into the column even in the standby state. This is to prevent the stationary phase inside the column from degenerating due to water content or oxygen infiltrating from the outside or, conversely, to prevent the stationary phase from flowing out from the column outlet.

In one embodiment, the gas chromatogram can have a column which separates respective components contained in a gas sample introduced via a carrier gas over time, wherein an analysis mode in which an analysis of said gas sample is executed and a standby mode in which an analysis is not executed can be switched and executed. In one embodiment, the GC has a plurality of chromatographic columns operated in parallel. In an alternative embodiment, the plurality of columns may be operated such that a first column is operated in analysis mode, while a second column is in standby mode.

In the present invention, the gas chromatogram comprises a detector for detecting components in gaseous mixtures. Examples of the detector include, but are not limited to, a thermal conductivity detector (TCD), a flame ionization detector (FID), a catalytic combustion detector (CCD), a discharge ionization detector (DID), a dry electrolytic conductivity detector (DELCD), an electron capture detector (ECD), a flame photometric detector (FPD), an atomic emission detector (AED), a hall electrolytic conductivity detector (ElCD), a helium ionization detector (HID), a nitrogen-phosphorus detector (NPD), an infrared detector (IRD), a mass spectrometer (MS), a photo-ionization detector (PID), a pulsed discharge ionization detector (PDD), or a thermionic ionization detector (TID).

In one embodiment, the gas chromatogram comprises a flame ionization detector.

A description of the general features and functionality of the gas chromatogram such as a carrier gas flow path, a gas sample flow path, a flow controller, a flow path switching part, and a gas sample guard column are omitted herein for brevity as these features are known.

In addition to a gas chromatogram, other gas analyzers may be employed to analyze the gaseous mixtures. These gas analyzers include, but are not limited to a mass spectrometer, an absorption spectrometer, or a combination comprising at least one of the foregoing.

In one embodiment, the on-line gas chromatography system optionally comprises a second filter located in the GC gas inlet line, upstream of the gas chromatogram. The second filter, if present, removes solid or liquid particles from the gaseous mixture prior to entering the gas chromatogram.

In the present disclosure, the on-line gas chromatography system utilizes a gaseous mixture, comprising a reactant gas and a purge gas. In one embodiment, no liquid vaporizer component is present in the on-line gas chromatography system, as all reactants are in gas form. Any trace liquid present in the gaseous mixture is considered to be an impurity, and may optionally be removed by the first or second filter.

The on-line gas chromatography system also contains a hydrostatic pressure regulator 111. The hydrostatic pressure regulator includes a vessel 112, an exit end of the GC gas outlet 113 line, an exit end of the by-pass line 114, and a liquid 115.

Hydrostatic pressure refers to the pressure exerted by a fluid at equilibrium at a given point within a fluid, due to the force of gravity. Hydrostatic pressure increases in proportion to depth measured from the surface because of the increasing weight of fluid exerting downward force from above. The hydrostatic pressure regulator in the present disclosure is a device used to maintain the inlet and outlet pressure across the GC. The liquid contained in the vessel in the hydrostatic pressure regulator can be an aqueous solution (e.g. water), an oil (e.g. mineral oil), or a liquid metal (i.e. Mercury). In one embodiment, the hydrostatic pressure regulator is not a pump.

In the on-line gas chromatography system of the present invention, the vessel contains the liquid and the vessel is in fluid communication with the exit end of the GC gas outlet line and the exit end of the by-pass line, wherein the exit end of the by-pass line is submerged in the liquid at a first depth and the exit end of the GC gas outlet line is submerged in the liquid at a second depth that is less than the first depth. The GC gas outlet line has a first hydrostatic pressure and the by-pass line has a second hydrostatic pressure, and the first hydrostatic pressure is less than the second hydrostatic pressure.

In one embodiment, the difference between the first depth and the second depth can be 1-10 millimeters (mm), preferably, 3-8 mm, even more preferably 4-6 mm In one embodiment, the difference between the first depth and the second depth is 4-6 mm, the liquid is water, and the pressure differential between the first and second hydrostatic pressure is 39-60 Pascals (Pa). In one embodiment, the difference between the first depth and the second depth is 4-6 mm, the liquid is mineral oil, and the pressure differential between the first and second hydrostatic pressure is 32-50 Pa. In one embodiment, the difference between the first depth and the second depth is 4-6 mm, the liquid is mercury, and the pressure differential between the first and second hydrostatic pressure is 530-810 Pa.

As can be seen in FIG. 1, the gas chromatogram is downstream of and in fluid communication with the reactor gas output line and the by-pass line through the GC gas inlet line, and the gas chromatogram is upstream of and in fluid communication with the hydrostatic pressure regulator through the GC gas outlet line. The reactor gas output line is in fluid communication with the gas chromatogram without a pump.

In one embodiment, the on-line gas chromatography system also has a purge line 116 in fluid communication with the reactor gas feed line upstream of the continuous flow reactor, the purge gas source, and separate from the feed gas source.

In one embodiment, the on-line gas chromatography system also includes a first three-way valve 117 downstream of the purge gas source and the feed gas source, upstream of the by-pass line and the reactor gas feed line.

In one embodiment, the on-line gas chromatography system also includes a second three-way valve 118 downstream of the reactor gas output line and upstream of the by-pass line and the GC gas inlet line.

In one embodiment, no four, five, or six-way valves are present in the reactor flow loop.

In one embodiment, the on-line gas chromatography system further incorporates a PC controlling unit 119, wherein the PC controlling unit controls a mass flow of the feed gas and the purge gas in the on-line gas chromatography system.

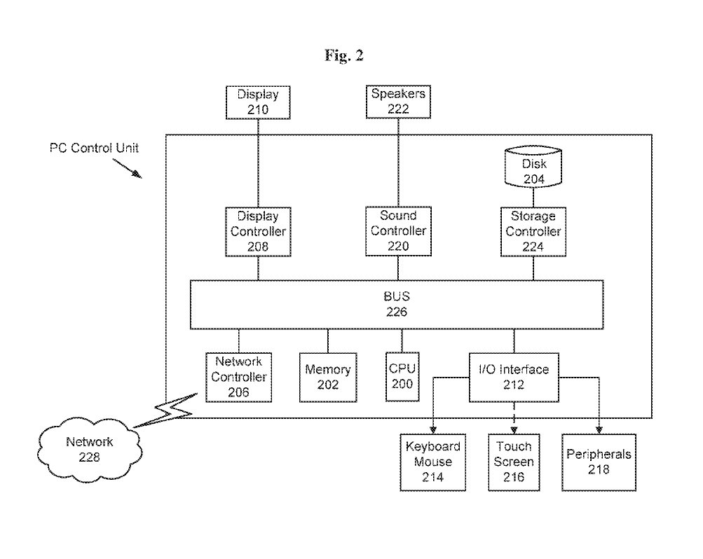

Next, a hardware description of the PC control unit according to exemplary embodiments is described with reference to FIG. 2. In FIG. 2, the PC control unit includes a CPU 200 which performs the processes described above. The process data and instructions can be stored in memory 202. These processes and instructions can also be stored on a storage medium disk 204 such as a hard drive (HDD) or portable storage medium or can be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the PC control unit communicates, such as a server or computer.

Further, the claimed advancements may be provided as a utility application, background daemon, or component of an operating system, or combination thereof, executing in conjunction with CPU 200 and an operating system such as Microsoft Windows 7, UNIX, Solaris, LINUX, Apple MAC-OS, including any updates thereof, and other systems known to those skilled in the art.

CPU 200 may be a Xenon or Core processor from Intel of America or an Opteron processor from AMD of America, or may be other processor types that would be recognized by one of ordinary skill in the art. Alternatively, the CPU 200 may be implemented on an FPGA, ASIC, PLD or using discrete logic circuits, as one of ordinary skill in the art would recognize. Further, CPU 200 may be implemented as multiple processors cooperatively working in parallel to perform the instructions of the inventive processes described above.

The PC control unit in FIG. 2 also includes a network controller 206, such as an Intel Ethernet PRO network interface card from Intel Corporation of America, for interfacing with network 228. As can be appreciated, the network 228 can be a public network, such as the Internet, or a private network such as an LAN or WAN network, or any combination thereof and can also include PSTN or ISDN sub-networks. The network 228 can also be wired, such as an Ethernet network, or can be wireless such as a cellular network including EDGE, 3G and 4G wireless cellular systems. The wireless network can also be WiFi, Bluetooth, or any other wireless form of communication that is known.

The PC control unit further includes a display controller 208, such as a NVIDIA GeForce GTX or Quadro graphics adaptor from NVIDIA Corporation of America for interfacing with display 210, such as a Hewlett Packard HPL2445w LCD monitor. A general purpose I/O interface 212 interfaces with a keyboard and/or mouse 214 as well as a touch screen panel 216 on or separate from display 210. General purpose 212 interface also connects to a variety of peripherals 218 including printers and scanners, such as an OfficeJet or DeskJet from Hewlett Packard.

A sound controller 220 is also provided in the PC control unit, such as Sound Blaster X-Fi Titanium from Creative, to interface with speakers/microphone 222 thereby providing sounds and/or music.

The general purpose storage controller 224 connects the storage medium disk 204 with communication bus 226, which may be an ISA, EISA, VESA, PCI, or similar, for interconnecting all of the components of the PC control unit. A description of the general features and functionality of the display 210, keyboard and/or mouse 214, as well as the display controller 208, storage controller 224, network controller 206, sound controller 220, and general purpose 110 interface 212 is omitted herein for brevity as these features are known.

According to a second aspect, the present disclosure relates to a method for on-line gas analysis of a catalytic reaction in the on-line gas chromatography system. The method involves first flowing a calibration gas mixture through the by-pass line into the gas chromatogram through the GC gas inlet line to record the composition of the calibration gas mixture, then feeding a reactor gas mixture through the fixed-bed continuous flow reactor to yield a gaseous reaction product. The method next involves feeding only the gaseous reaction product exiting the fixed-bed continuous flow reactor to the GC gas inlet line to determine the composition of the gaseous reaction product.

A response factor is the ratio between a signal produced by an analyte, and the quantity of analyte which produces the signal. Ideally, and for easy computation, this ratio is unity. In real-world scenarios, this is often not the case. Therefore, response factors are commonly used in chromatography to compensate for the irreproducibility of injection volumes. To compensate for this error, a known amount of an internal standard (a second compound that does not interfere with the analysis of the primary analyte) is added to all solutions (standards and unknowns). This way if the injection volumes (and hence the peak areas) differ slightly, the ratio of the areas of the analyte and the internal standard will remain constant from one run to the next. In one embodiment, a purge gas (i.e. an inert gas) is used as an internal standard.

In one embodiment, the calibration gas mixture and the reactor gas mixture have the same composition, and the mixture comprises a hydrocarbon gas and a purge gas.

In one embodiment, the calibration gas mixture and the reactor gas mixture are the same, and the mixture comprises 75-95%, preferably 80-90% of a hydrocarbon gas and 5-25%, preferably 10-20% of a purge gas.

In one embodiment, the first flowing of a calibration gas is carried out while pre-heating the reactor to a catalytic reaction temperature.

In one embodiment, the reactor is pre-heated at 10-30° C./min, preferably 15-250° C./min, more preferably 17-22° C./min at 20-40, preferably 25-35, more preferably 28-32 ml/min in argon (Ar).

In terms of the present invention, the method may additionally involve a catalyst pre-treatment step prior to feeding a reactor gas mixture through the reactor. In one embodiment, the catalyst pre-treatment involves pre-heating the catalyst to 500-800° C., preferably 600-700° C., more preferably 630-670° C. In one embodiment, the catalyst pre-treatment includes fully reducing the catalyst by flowing a reducing gas through the reactor. In one embodiment, the reducing gas comprises hydrogen gas.

In one embodiment, the catalytic reaction temperature is 400-700° C., preferably 500-600° C., more preferably 530-570° C.

In one embodiment, the reactor gas mixture is fed through the fixed-bed continuous flow reactor at 15-35, preferably 20-30, more preferably 23-27 ml/min.

A dehydrogenation reaction is a reaction that converts saturated alkanes to form corresponding alkenes. The formed alkenes may be formed as any unsaturated Isomer. Dehydrogenation of hydrocarbons can be accomplished thermally or catalytically.

In one embodiment, the reactor gas mixture comprises a hydrocarbon gas, the catalytic reaction is a hydrocarbon dehydrogenation reaction, and the composition of gaseous reaction product comprises a dehydrogenated reaction product.

Hydrocarbon cracking is the process whereby organic molecules, such as hydrocarbons, are broken down into simpler molecules, such as light hydrocarbons, by the breaking of carbon-carbon bonds in the hydrocarbon precursors. The process of the present disclosure generally forms light olefins (i.e. alkenes) and/or saturated hydrocarbons that have lower molecular weight than the starting material. Light olefins or alkenes include any unsaturated open-chain hydrocarbons, such as ethylene, propylene, butylene, etc.

In one embodiment, the reactor gas mixture comprises a hydrocarbon gas, the catalytic reaction is a hydrocarbon cracking reaction, and the composition of gaseous reaction product comprises a cracked hydrocarbon reaction product.

The examples below are intended to further illustrate protocols for analyzing catalytic reactions using the gas chromatography system.

### Example 1

### Catalytic Experiments

As shown in FIG. 1, catalytic experiments were carried out using a fixed-bed, continuous flow reactor 102 connected to an on-line GC 108 (HP 6890 Series, TCD and FID, packed columns) controlled by GC ChemStation (Agilent Rev. B.03.01). The micro reactor made of a quartz tube (OD: 14 mm and ID: 10 mm) was used. The catalyst was heated to 650° C. at 20° C./min at 30 ml/min in Ar. Then it was fired at 30 ml/min in synthetic air. This process was performed to ensure the fresh condition of catalyst materials and to remove coke generated from the dehydrogenation. A desired experimental temperature was reached at 540° C. in Ar. The catalyst was fully reduced by a 15 ml/min of hydrogen for 6 minutes. After purging the reactor with Ar for 5 minutes, a mixture of isobutane and Ar (10-20%) was introduced to the reactor at 25 ml/min. Then GC measurements were initiated to measure product gases for a 30 minutes interval.

### Example 2

### Material Preparation

As-received chromia based catalysts from Sud-Chemie (Clariant) were crushed with a mortar and pestle. To obtain a regular particle size, the crushed particles were sieved (20/40 mesh). Ar was used as a probing gas since nitrogen was used as a carrier gas to detect hydrogen. For obtaining the calibration factor of the probing gas of Ar, at least three times of GC measurements were performed at room temperature before initiating catalyst experiments. Using a calibration mixture, response factors (RF) for each species were calculated.

### Example 3

### Results and Discussion

In this invention, a by-pass line 107 is designed to efficiently perform a calibration of the feed and pre-mixed calibration gases. As shown in FIG. 1, while the heating of the reactor is carried out, the gaseous mixture containing a reactant and a probing gas was measured using the GC 108 as a reference, saving time. When the catalytic reaction experiment is carried out, the gas pathway was through 103, while 107 and 116 were closed. Accordingly, the outlet 104 of the reactor was connected to the GC sampling system. During the time-consuming pre-heating of the reactor, the GC measurements of the feed or the calibration mixture were executed by closing 103 and opening 107. This switching was done easily by using three-way valve 117. While 107 was connected to the gas-sampling line, the outlet 118 was vented and 116 was open to provide a purging gas.

The GC gas inlet line 109 is normally 1/16^{th} of an inch outer diameter (OD). Therefore, it is difficult to sample gases after the reactor outlet without using a pump. In this disclosure, a vessel 112 with water was connected to the exhaust GC line 110 and the main product gas outlet from the reactor 104 or the by-pass line 107 was also submerged. As shown in FIG. 1, a proper pressure difference (ΔP) can be generated by making a slight height difference (Δh; ˜5 mm) of the columns of the main vent line (h₁) and the GC vent line (h₂). Hydrostatic pressure in a liquid can determined using p=hρg, where p=pressure (Newtons per square meter (N/m², Pa), h=height of fluid column (meter (m)), ρ=density of liquid (kilograms per cubic meter (kg/m³), and g=the gravitational constant (9.8 meters per square second (m/s²). Therefore, ΔP is associated with Δh. The slight hydrostatic pressure difference without any instrument makes a consistent sampling of gases with a 1/16 inch OD stainless tube. Furthermore, the smooth gas sampling using the approach directly improves the stability of GC measurements.

To avoid the problem discussed above, a simple, straightforward calibration method which is not affected by a changeable feed input was performed by using a small amount of inert gases (i.e., nitrogen and argon) as a probing gas for GC measurements. If hydrogen has to be detected, nitrogen carrier gas should be used. Accordingly, argon gas was applied as a probing gas. In addition, adding an inert gas into a reactant gas may cause an unnecessary side effect, such as the alternation of partial pressure. Thus 5-25% of an inert gas is recommended, preferably 10-20%. For the GC detectors, it is required to use a thermal conductivity detector (TCD) for inert gas measurements. In this disclosure, as a benchmark study, the dehydrogenation of isobutane (C₄H₁₀) to isobutene (C₄H₈) with 10-20% of argon was carried out using chromium oxide based catalysts provided by Sud-Chemie. To detect hydrocarbons, a flame ionization detector (FID) was used.

Using the setup and approach, chromia based catalysts were tested for the dehydrogenation of isobutane to isobutene. As summarized in Table 1, by using the gas-sampling and a probing gas, a successful dehydrogenation result was obtained. The experiment was performed at 1 atmosphere (atm).

TABLE 1
Compilation of experimental conditions
and results using chromia based catalysts

| Conditions | values |
|---|---|
| GHSV (hr⁻¹) | 0.1 |
| Temperature (° C.) | 540 |
| Conversion of isobutane (C₄H₁₀) (%) | 52.5 |
| Selectivity to isobutene (C₄H₈) (%) | 86.8 |
| Yield of isobutene (C₄H₈) (%) | 45.6 |

The system and method disclosed herein include at least the following embodiments:

### Embodiment 1

An on-line gas chromatography system for a fixed-bed continuous flow reactor, comprising: a reactor flow loop, comprising: a fixed-bed continuous flow reactor having a reactor gas feed line and a reactor gas output line, a purge gas source, a feed gas source, and a by-pass line; wherein the by-pass line, the reactor gas feed line, the reactor gas output line, the purge gas source, and the feed gas source, are in fluid communication; a gas chromatogram having a gas chromatogram gas inlet line and a gas chromatogram gas outlet line; and a hydrostatic pressure regulator, comprising: a vessel, an exit end of the gas chromatogram gas outlet line, an exit end of the by-pass line, and a liquid; wherein the vessel contains the liquid and the vessel is in fluid communication with the exit end of the gas chromatogram gas outlet line and the exit end of the by-pass line; and wherein the exit end of the by-pass line is submerged in the liquid at a first depth and the exit end of the gas chromatogram gas outlet line is submerged in the liquid at a second depth that is less than the first depth, wherein the gas chromatogram gas outlet line has a first hydrostatic pressure and the by-pass line has a second hydrostatic pressure, and the first hydrostatic pressure is less than the second hydrostatic pressure; wherein the gas chromatogram is downstream of and in fluid communication with the reactor gas output line and the by-pass line through the gas chromatogram gas inlet line, and the gas chromatogram is upstream of and in fluid communication with the hydrostatic pressure regulator through the GC gas outlet line; and wherein the reactor gas output line is in fluid communication with the gas chromatogram without a pump.

### Embodiment 2

The on-line gas chromatography system of Embodiment 1, further comprising a purge line in fluid communication with the reactor gas feed line upstream of the continuous flow reactor, the purge gas source, and separate from the feed gas source.

### Embodiment 3

The on-line gas chromatography system of Embodiment 1 or Embodiment 2, further comprising a first three-way valve downstream of the purge gas source, and the feed gas source, upstream of the by-pass line and the reactor gas feed line.

### Embodiment 4

The on-line gas chromatography system of any of the preceding embodiments, further comprising a second three-way valve downstream of the reactor gas output line and upstream of the by-pass line and the GC gas inlet line.

### Embodiment 5

The on-line gas chromatography system of any of the preceding embodiments, further comprising a PC controlling unit, wherein the PC controlling unit controls a mass flow of the feed gas and the purge gas in the on-line gas chromatography system.

### Embodiment 6

The on-line gas chromatography system of any of the preceding embodiments, wherein the gas chromatogram comprises a flame ionization detector.

### Embodiment 7

The on-line gas chromatography system of any of the preceding embodiments, wherein the fixed-bed continuous flow reactor comprises a catalyst.

### Embodiment 8

The on-line gas chromatography system of any of the preceding embodiments, wherein the catalyst comprises chromium oxide.

### Embodiment 9

The on-line gas chromatography system of any of the preceding embodiments, wherein the feed gas is a hydrocarbon gas.

### Embodiment 10

The on-line gas chromatography system of any of the preceding embodiments, wherein the purge gas is argon, nitrogen, or a combination comprising at least one of the foregoing.

### Embodiment 11

A method for on-line gas analysis of a catalytic reaction in the on-line gas chromatography system of any of the preceding embodiments, comprising: flowing a calibration gas mixture through the by-pass line into the gas chromatogram through the gas chromatogram gas inlet line to record the composition of the calibration gas mixture; feeding a reactor gas mixture through the fixed-bed continuous flow reactor to yield a gaseous reaction product; and feeding only the gaseous reaction product exiting the fixed-bed continuous flow reactor to the GC gas inlet line to determine the composition of the gaseous reaction product.

### Embodiment 12

The method of Embodiment 11, wherein the calibration gas mixture and the reactor gas mixture are the same, and wherein the mixture comprises a hydrocarbon gas and a purge gas.

### Embodiment 13

The method of Embodiment 11 or Embodiment 12, wherein the calibration gas mixture and the reactor gas mixture are the same, and the mixture comprises 80-90% of a hydrocarbon gas and 10-20% of a purge gas.

### Embodiment 14

The method of any of Embodiments 11-13, wherein the reactor gas mixture comprises a hydrocarbon gas, the catalytic reaction is a hydrocarbon dehydrogenation reaction, and the composition of gaseous reaction product comprises a dehydrogenated reaction product.

### Embodiment 15

The method of any of Embodiments 11-14, wherein the reactor gas mixture comprises a hydrocarbon gas, the catalytic reaction is a hydrocarbon cracking reaction, and the composition of gaseous reaction product comprises a cracked hydrocarbon reaction product.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The terms “front”, “back”, “bottom”, and/or “top” are used herein, unless otherwise noted, merely for convenience of description, and are not limited to any one position or spatial orientation. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

Unless otherwise specified herein, any reference to standards, regulations, testing methods and the like, such as ASTM D1003, ASTM D4935, ASTM 1746, FCC part 18, CISPR11, and CISPR 19 refer to the standard, regulation, guidance or method that is in force at the time of filing of the present application.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An on-line gas chromatography system for a fixed-bed continuous flow reactor, comprising:
a reactor flow loop, comprising:
a fixed-bed continuous flow reactor having a reactor gas feed line and a reactor gas output line,
a purge gas source,
a feed gas source, and
a by-pass line;
wherein the by-pass line, the reactor gas feed line, the reactor gas output line, the purge gas source, and the feed gas source, are in fluid communication;
a gas chromatogram having a gas chromatogram gas inlet line and a gas chromatogram gas outlet line; and
a hydrostatic pressure regulator, comprising:
a vessel,
an exit end of the gas chromatogram gas outlet line, an exit end of the by-pass line, and
a liquid;
wherein the vessel contains the liquid and the vessel is in fluid communication with the exit end of the gas chromatogram gas outlet line and the exit end of the by-pass line; and
wherein the exit end of the by-pass line is submerged in the liquid at a first depth and the exit end of the gas chromatogram gas outlet line is submerged in the liquid at a second depth that is less than the first depth, wherein the gas chromatogram gas outlet line has a first hydrostatic pressure and the by-pass line has a second hydrostatic pressure, and the first hydrostatic pressure is less than the second hydrostatic pressure;
wherein the gas chromatogram is downstream of and in fluid communication with the reactor gas output line and the by-pass line through the gas chromatogram gas inlet line, and the gas chromatogram is upstream of and in fluid communication with the hydrostatic pressure regulator through the GC gas outlet line; and
wherein the reactor gas output line is in fluid communication with the gas chromatogram without a pump.

2. The on-line gas chromatography system of claim 1, further comprising a purge line in fluid communication with the reactor gas feed line upstream of the continuous flow reactor, the purge gas source, and separate from the feed gas source.

3. The on-line gas chromatography system of claim 1, further comprising a first three-way valve downstream of the purge gas source, and the feed gas source, upstream of the by-pass line and the reactor gas feed line.

4. The on-line gas chromatography system of claim 1, further comprising a second three-way valve downstream of the reactor gas output line and upstream of the by-pass line and the GC gas inlet line.

5. The on-line gas chromatography system of claim 1, further comprising a PC controlling unit, wherein the PC controlling unit controls a mass flow of the feed gas and the purge gas in the on-line gas chromatography system.

6. The on-line gas chromatography system of claim 1, wherein the gas chromatogram comprises a flame ionization detector.

7. The on-line gas chromatography system of claim 1, wherein the fixed-bed continuous flow reactor comprises a catalyst.

8. The on-line gas chromatography system of claim 1, wherein the catalyst comprises chromium oxide.

9. The on-line gas chromatography system of claim 1, wherein the feed gas is a hydrocarbon gas.

10. The on-line gas chromatography system of claim 1, wherein the purge gas is argon, nitrogen, or a combination comprising at least one of the foregoing.

11. A method for on-line gas analysis of a catalytic reaction in the on-line gas chromatography system of claim 1, comprising:
flowing a calibration gas mixture through the by-pass line into the gas chromatogram through the gas chromatogram gas inlet line to record the composition of the calibration gas mixture;
feeding a reactor gas mixture through the fixed-bed continuous flow reactor to yield a gaseous reaction product; and
feeding only the gaseous reaction product exiting the fixed-bed continuous flow reactor to the GC gas inlet line to determine the composition of the gaseous reaction product.

12. The method of claim 11, wherein the calibration gas mixture and the reactor gas mixture are the same, and wherein the mixture comprises a hydrocarbon gas and a purge gas.

13. The method of claim 11, wherein the calibration gas mixture and the reactor gas mixture are the same, and the mixture comprises 80-90% of a hydrocarbon gas and 10-20% of a purge gas.

14. The method of claim 11, wherein the reactor gas mixture comprises a hydrocarbon gas, the catalytic reaction is a hydrocarbon dehydrogenation reaction, and the composition of gaseous reaction product comprises a dehydrogenated reaction product.

15. The method of claim 11, wherein the reactor gas mixture comprises a hydrocarbon gas, the catalytic reaction is a hydrocarbon cracking reaction, and the composition of gaseous reaction product comprises a cracked hydrocarbon reaction product.
